(19) United States
(12) Patent Application Publication
(10) Pub. No.: US 2019/0372186 A1
(43) Pub. Date: Dec. 5, 2019

(54) SULFONE ELECTROLYTES FOR CAPACITOR-ASSISTED BATTERIES

(71) Applicant: GM GLOBAL TECHNOLOGY OPERATIONS LLC, DETROIT, MI (US)

(72) Inventors: Dewen Kong, Shanghai (CN); Zhe Li, Shanghai (CN); Xiusheng Zhang, Shanghai (CN)

(21) Appl. No.: 15/993,352

(22) Filed: May 30, 2018

(51) Int. Cl. H01M 12/00; H01G 11/62; H01G 11/06

(52) U.S. Cl. CPC H01M 12/005; H01M 2300/0042; H01G 11/06; H01G 11/62

(57) ABSTRACT

Provided are capacitor-assisted lithium batteries (CAB), comprising an electrolyte comprising one or more lithium salts, and one or more sulfone molecules, wherein the one or more sulfone molecules comprise sulfolane, a substituted sulfolane, and/or a substituted SO₂. The electrolyte may further include one or more solvents. The sulfone-based electrolyte inhibits or prevents undesired gas generation.

### INTRODUCTION

Lithium ion batteries describe a class of rechargeable batteries in which lithium ions move between a negative electrode (i.e., anode) and a positive electrode (i.e., cathode). Liquid and polymer electrolytes can facilitate the movement of lithium ions between the anode and cathode. Lithium-ion batteries are growing in popularity for defense, automotive, and aerospace applications due to their high energy density and ability to undergo successive charge and discharge cycles.

### SUMMARY

Provided are capacitor-assisted lithium batteries (CAB) which include a plurality of electrodes, wherein at least one or the electrodes is a hybrid battery-capacitor electrode or a capacitor electrode, and a non-aqueous liquid electrolyte comprising one or more sulfone molecules defined by the chemical formula:

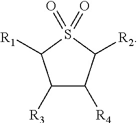

Each of R₁, R₂, R₃, and R₄ represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, a mono, di, or tri-alkyl-substituted phenyl wherein the alkyl substituent comprises CₙH₂ₙ in which n=1-20, a nitro group, a cyanogen group, or a halogen group. The sulfone can include tetramethylene sulfone and the electrolyte can further include LiPF₆, ethylene carbonate, dimethyl carbonate, and ethyl methyl carbonate. The sulfone can include tetramethylene sulfone and the electrolyte can further include LiN(CF₃SO₂)₂, and dimethyl carbonate. The sulfone can be tetramethylene sulfone and the electrolyte can further include LiPF₆, LiBF₄, LiN(CF₃SO₂)₂, ethylene carbonate, dimethyl carbonate, and ethyl methyl carbonate. The electrolyte can be about 15% by volume to about 30% by volume sulfone. The one or more lithium salts can include LiCF₃SO₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiAsF₆, and combinations thereof.

Provided are capacitor-assisted lithium batteries (CAB) which include a plurality of electrodes, wherein at least one or the electrodes is a hybrid battery-capacitor electrode or a capacitor electrode, and a non-aqueous liquid electrolyte comprising one or more sulfone molecules defined by the chemical formula:

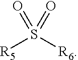

Each of R₅ and R₆, represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₙ, wherein n=1-10 and m=1-10, a phenyl group, or a mono, di, or tri-alkyl-substituted phenyl wherein the alkyl substituent comprises CₙH₂ₙ in which n=1-20. The sulfone can be ethyl methanesulfonate and the electrolyte can further include LiN(CF₃SO₂)₂, propylene carbonate, diethyl carbonate, and ethyl methyl carbonate. The sulfone can be ethyl methanesulfonate and the electrolyte can further include LiPF₆, propylene carbonate, dimethyl carbonate, and diethyl carbonate. The electrolyte can include about 15% by volume to about 30% by volume sulfone. The one or more lithium salts can be LiCF₃SO₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiAsF₆, and combinations thereof. Provided are capacitor-assisted lithium batteries (CAB) which include an electrolyte comprising one or more lithium salts, and one or more sulfone molecules defined by the chemical formula:

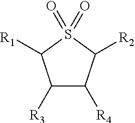

wherein each of R₁, R₂, R₃, and R₄ represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, a mono, di, or tri-alkyl-substituted phenyl wherein the alkyl substituent comprises CₙH₂ₙ in which n=1-20, a nitro group, a cyanogen group, or a halogen group, or

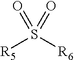

wherein each of R₅ and R₆, represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, or a mono, di, or tri-alkyl-substituted phenyl wherein the alkyl substituent comprises CₙH₂ₙ in which n=1-20. Up to about 60% by volume of the electrolyte can include sulfone. The electrolyte can include about 15% by volume to about 30% by volume sulfone. The electrolyte can further include one or more of ethylene carbonate, diethyl carbonate, dimethyl carbonate, ethyl methyl carbonate, propylene carbonate, butylene carbonate, methyl formate, methyl acetate, methyl propionate, γ-butyrolactone, γ-valerolactone, 1,2-dimethoxyethane, 1-2-diethoxyethane, ethoxymethoxyethane, tetrahydrofuran, 2-methyltetrahydrofuran, acetonitrile, 3-methoxypropionitrile, dimethyl ether. The electrolyte can further include a carbonate-based solvent. The one or more lithium salts can include LiCF₃SO₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, Li SO₃CF₃, LiAsF₆, and combinations thereof. The concentration of the lithium salt in the electrolyte can be about 1 mol/L to about 6 mol/L.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic view of a capacitor-assisted battery cell, according to one or more embodiments;

FIG. 2 illustrates a schematic side-view of a prismatic capacitor-assisted battery comprising a plurality of the electrodes, according to one or more embodiments; and

FIG. 3 illustrates a graph of current data collected from three capacitor-assisted batteries, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are capacitor-assisted batteries (“CAB”) which are hybrid electrochemical cells utilizing one or more hybrid electrodes comprising anode and/or cathode materials for lithium-ion batteries in varying combinations with compatible capacitor materials. The CABs exhibit beneficial properties of both lithium-ion batteries and capacitors, such as enhanced energy densities (Wh/kg), power densities (W/kg), and improved long-term performance. The energy density and power density characteristics of a given hybrid cell can vary depending on the quantity, composition, and ratio of battery electrode materials and capacitor electrode materials applied to the plurality of hybrid cell electrodes. In general, energy density is improved by increasing battery material content and/or by selecting high specific energy battery electrode materials while the power density of the hybrid electrochemical cell is increased by increasing the content of capacitor electrode material and/or by selecting high specific power density capacitor compositions. The CABs provided herein comprise electrolytes which suppress detrimental gas generation during which particularly occurs during high states of charge. Further, CABs provided herein are suitable for cold-weather applications (e.g., cold-cranking).

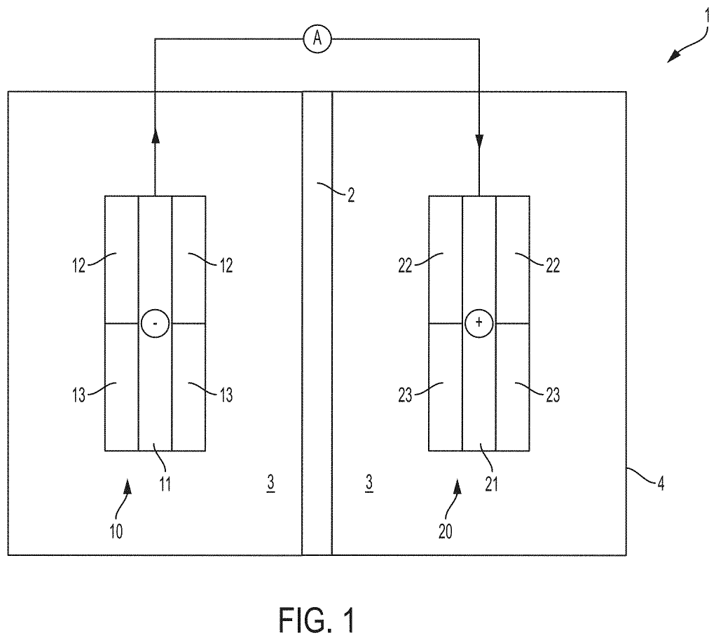

FIG. 1 illustrates a CAB 1 comprising a negative electrode (i.e., the anode) 10, a positive electrode (i.e., the cathode) 20, an electrolyte 3 operatively disposed between the anode 10 and the cathode 20, and a separator 2. Anode 10, cathode 20, and electrolyte 3 can be encapsulated in container 4, which can be a hard case (e.g., a metallic case) or a soft pouch (e.g., a laminate pouch made from polymer and/or nylon coating on thin aluminum metal foil), for example. The anode 10 and cathode 20 are situated on opposite sides of separator 2 which can comprise a microporous polymer or other suitable material capable of conducting lithium ions and optionally electrolyte 3 (i.e., liquid electrolyte).

CAB 1 generally operates by reversibly passing lithium ions between the battery portions of anode 10 and/or cathode 20, via electrolyte 3, and adsorbing/desorbing lithium ions on the capacitor portions of anode 10 and/or cathode 20. Lithium ions move from battery portions of cathode 20 to battery portions of anode 10 while charging, and move from battery portions of anode 10 and to battery portions of cathode 20 while discharging. Additionally, lithium ions move adsorb on capacitor portions of electrodes (e.g., anode 10 and/or cathode 20) during charging, and desorb from capacitor portions of electrodes (e.g., anode 10 and/or cathode 20) during discharging. Accordingly, at the beginning of a discharge, anode 10 contains a high concentration of intercalated lithium ions while cathode 20 is relatively depleted, and establishing a closed external circuit between anode 10 and cathode 20 under such circumstances causes intercalated lithium ions to be extracted from anode 10. The extracted lithium atoms are split into lithium ions and electrons as they leave an intercalation host at an electrode-electrolyte interface. The lithium ions are carried through the micropores of separator 2 from anode 10 to cathode 20 by the ionically conductive electrolyte 3 while, at the same time, the electrons are transmitted through the external circuit from anode 10 to cathode 20 to balance the overall electrochemical cell. This flow of electrons through the external circuit can be harnessed and fed to a load device until the level of intercalated lithium in the negative electrode falls below a workable level or the need for power ceases. The arrows indicate that current is flowing out of anode 10 and that current is flowing into cathode 20, and thus CAB 1 is shown in a charging state.

CAB 1 may be recharged after a partial or full discharge of its available capacity. To charge or re-power the CAB 1, an external power source (not shown) is connected to the positive and the negative electrodes to drive the reverse of CAB 1 discharge electrochemical reactions. That is, during charging, lithium ions are extracted from battery portions of cathode 20 to produce lithium ions and electrons, and anions are adsorbed on capacitor portions of cathode 20. The lithium ions are carried back through the separator 2 via the electrolyte 3, and the electrons are driven back through the external circuit A, both towards anode 10. The lithium ions and electrons are ultimately intercalated into the battery portions of anode 10, and cations are adsorbed onto capacitor portions of anode 10, thus replenishing it with intercalated lithium for future cell discharge.

CAB 1, or a module or pack comprising a plurality of CABs 1 connected in series and/or in parallel, can be utilized to reversibly supply power and energy to an associated load device. CABs may also be used in various consumer electronic devices (e.g., laptop computers, cameras, and cellular/smart phones), military electronics (e.g., radios, mine detectors, and thermal weapons), aircrafts, and satellites, among others. CABs, modules, and packs may be incorporated in a vehicle such as a hybrid electric vehicle (HEV), a battery electric vehicle (BEV), a plug-in HEV, or an extended-range electric vehicle (EREV) to generate enough power and energy to operate one or more systems of the vehicle. For instance, the CABs, modules, and packs may be used in combination with a gasoline or diesel internal combustion engine to propel the vehicle (such as in hybrid electric vehicles), or may be used alone to propel the vehicle (such as in battery-powered vehicles).

Anode 10 includes a two-sided current collector 11 and cathode 20 includes a two-sided current collector 21. Current collectors 11 and 21 are generally formed from thin metallic foils, of varying sizes and geometries. The current collectors 11 and 21 associated with the two electrodes 10 and 20 are connected by an external circuit A that allows an electric current to pass between the electrodes to electrically balance the related migration of lithium ions and adsorption/desoprtion of cations and anions. The anode current collector 11 can comprise copper, aluminum, stainless steel, clad foil, or any other appropriate electrically conductive material known to skilled artisans. The cathode current collector 21 can comprise aluminum, stainless steel or any other appropriate electrically conductive material known to skilled artisans, and can be formed in a foil or grid shape. Current collectors 11 and 21 may have a thickness of about 3 micrometers to about 30 micrometers, in some embodiments.

The anode current collector 11 has a lithium intercalation host material 13 applied to one or both sides thereof in one or more anode regions and/or a capacitor material 12 applied to one or both sides in one or more capacitor regions. The cathode current collector 21 has a lithium-based active material 23 applied to one or both sides thereof in one or more cathode regions and/or a capacitor material 22 applied to one or both sides in one or more capacitor regions. The active material 23 has a higher electric potential than the intercalation host material 13.

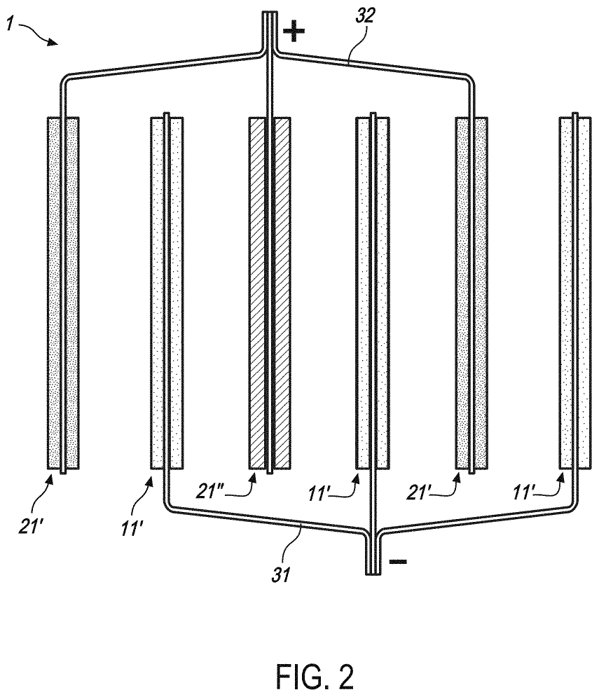

The CAB 1 may have various hybrid orientations. In general, CAB 1 includes a plurality of electrodes comprising coated current collectors, wherein at least one electrode comprises capacitor material (i.e., at least one electrode is a capacitor electrode or a hybrid electrode). For example, FIG. 2 illustrates a schematic side-view of a prismatic CAB 1 comprising a plurality of the electrodes. Specifically, a plurality of battery anodes 11′ are stacked in an alternating fashion with a plurality of battery cathodes 21′ and a capacitor cathode 21″. Each of the anodes are electrically connected via an anode busbar 31, and each of the cathodes are electrically connected via a cathode busbar 32. The separators 2, electrolyte 3, and other appurtenant components of such CABs are omitted for clarity. Other various CAB embodiments, among others, are disclosed in co-owned U.S. patent application Ser. Nos. 15/221,963 and 15/704,122, the contents of which are herein incorporated in their entirety.

In one embodiment, at least one of the anode 10 and the cathode 20 is a hybrid electrode (i.e., includes both host material 13 or active material 23 and capacitor material 12 or 22, respectively, applied to one or more sides of its respective current collector) and the other electrode is a battery electrode (i.e., includes only host material 13 or active material 23 applied to one or more sides of its respective current collector). A hybrid electrode may have battery material (i.e., active material or host material) and capacitor material applied thereto in discrete regions, overlapping layers, or blended regions, for example. Accordingly, the CAB may include a hybrid anode 10 comprising host material 13 and capacitor material 12 applied to its current collector 11 and a battery cathode 20 comprising only active material 23 applied to its current collector 21 (i.e., no, or substantially no, capacitor material 22 applied to its current collector 21). Alternatively, the CAB may include a battery anode 10 comprising only host material 13 applied to its current collector 11 (i.e., no, or substantially no, capacitor material 12 applied to its current collector 11) and a hybrid cathode 20 comprising active material 23 and capacitor material 22 applied to its current collector 21. Alternatively, the CAB may include a hybrid anode 10 comprising host material 13 and capacitor material 12 applied to its current collector 11 and a hybrid cathode 20 comprising active material 23 and capacitor material 22 applied to its current collector 21.

In another embodiment of the CAB 1, one of the anode 10 and the cathode 20 is a hybrid electrode (i.e., includes both host material 13 or active material 23 and capacitor material 12 or 22, respectively, applied to one or more sides of its respective current collector), and the other electrode comprises a capacitor electrode. Accordingly, the CAB may include a hybrid anode 10 comprising host material 13 and capacitor material 12 applied to its current collector 11 and a capacitor cathode 20 comprising only capacitor material 22 applied to its current collector 21 (i.e., no, or substantially no, active material 23 applied to its current collector 21). Alternatively, the CAB may include a capacitor anode 10 comprising only capacitor material 12 applied to its current collector 11 (i.e., no, or substantially no, host material 13 applied to its current collector 11), and a hybrid cathode 20 comprising active material 23 and capacitor material 22 applied to its current collector 21.

In another embodiment of the CAB 1, one of the anode 10 and the cathode 20 is a battery electrode (i.e., includes only host material 13 or active material 23 applied to one or more sides of its respective current collector), and the other electrode comprises a capacitor electrode. Accordingly, the CAB may include a battery anode 10 comprising only host material 13 applied to its current collector 11 (i.e., no, or substantially no, capacitor material 12 applied to its current collector 11) and a capacitor cathode 20 comprising only capacitor material 22 applied to its current collector 21 (i.e., no, or substantially no, active material 23 applied to its current collector 21). Alternatively, the CAB may include a capacitor anode 10 comprising only capacitor material 12 applied to its current collector 11 (i.e., no, or substantially no, host material 13 applied to its current collector 11), and a battery cathode 20 comprising only active material 23 applied to its current collector 21 (i.e., no, or substantially no, capacitor material 22 applied to its current collector 21).

For a given hybrid anode 10, the capacitor material 12 applied to the anode current collector 11 is different from the anode host material 13. Similarly, for a given hybrid cathode 20, the capacitor material 22 applied to the cathode current collector 21 is different from the cathode active material 23. In general, current collectors 11 and 21 are coated on both sides with porous layers of individual electrode materials (host material 13, active material 23, and capacitor material 12 and 22). The host material 13 or active material 23 and capacitor material 12 or 22, respectively, can be applied in respective, distinct, non-overlapping regions, or can be layered or blended in the same region. In some embodiments wherein the host material 13 or active material 23 and capacitor material 12 or 22 are applied in distinct, non-overlapping regions, the anode 10 and/or the cathode 20 comprise gaps between the anode region(s) or cathode region(s) and the capacitor region(s) of the current collector 11 or 21, respectively. Such gaps comprise uncoated (i.e., bare) regions of the current collector 11 or 21 which accommodate for expansion of host material 13, active material 23, and capacitor material 12 and 22 which may occur during hybrid cell charging and discharging. The thicknesses of the coating layers can be varied to tune the capacity of the layer to accept and release lithium ions and anions of the lithium electrolyte solution. The thicknesses of the coatings are not necessarily the same on each side of the current collector.

Host material 13 can include any lithium host material that can sufficiently undergo lithium ion intercalation, deintercalation, and alloying, while functioning as the negative terminal of the CAB 1. In one embodiment, the host material 13 comprises lithium titanate. In some embodiments, the host material 13 comprises one or more of lithium titanate (“LTO”), lithium metals, silicon, silicon-lithium alloys, silicon-tin alloys, silicon-copper alloys, tin-copper alloys, silicon oxide, tin, tin oxides, cobalt oxides, iron oxides, titanium oxides (e.g., TiO₂), TiNb2O7, and low-surface area carbon material including hard carbon, soft carbon, and graphite. During cell-discharge, electrons are released from the host material 13 into the electrical power-requiring external circuit A and lithium ions are released (de-intercalated) into an anhydrous lithium ion conducting electrolyte 3. A small amount of conductivity enhancing carbon particles may be mixed with the host material 13, in some embodiments.

Active material 23 can include any lithium-based active material that can sufficiently undergo lithium intercalation and deintercalation while functioning as the positive terminal of the CAB 1. In one embodiment, the active material 23 comprises lithium manganese oxide. In some embodiments, the active material 23 comprises lithium-metal-oxides and lithium metal phosphates, which include, but are not limited to, lithium manganese oxide, lithium nickel oxide, lithium cobalt oxide, lithium nickel manganese cobalt oxide, or lithium iron phosphates. Specific lithium metal oxides include lithium aluminum manganese oxide (e.g., LiₓAl_{y}Mn_{1-y}O₂) and lithium transitional metal oxides such as spinel-structured lithium manganese oxide LiMn₂O₄ (“LMO”), spinel-structured lithium nickel-manganese oxides (e.g., LiNi_{0.5}Mn_{1.5}O₄) lithium cobalt oxide (e.g., LiCoO₂), lithium nickel-manganese-cobalt oxide (e.g., Li(NiₓMn_{y}Co_{z})O₂, wherein x+y+z=1) (“NMC”), lithium nickel oxide (e.g., LiNiO₂), lithium vanadium oxide (e.g., LiV₂O₅), or a lithium iron polyanion oxide such as lithium iron phosphate LiFePO₄ (“LFP”), or lithium iron fluorophosphate (Li₂FePO₄F). Active material 23 can also include a polymer binder material to structurally hold the lithium-based active material together. Active material 23 can be mixed with, or applied in combination with a thin layer, conductivity-enhanced carbon, graphite, or carbon fibers to improve the electric conductivity.

Capacitor material 12 and/or 22 comprises high-surface area carbon materials, or activated carbon materials (“AC”), in some embodiments. In some embodiments, the capacitor material 12 and/or 22 comprises AC, graphite, carbon aerogel, carbide-derived carbon, graphene, graphene oxide, carbon nanotubes, oxides of lead, germanium, cobalt, nickel, copper, iron, manganese, ruthenium, rhodium, palladium, chromium, molybdenum, tungsten, or niobium, metal sulfides (e.g., TiS₂, NiS, Ag₄Hf₃S₈, CuS, FeS, or FeS₂). AC can comprise AC particles or AC fibers, for example. In some embodiments, capacitor material 22 can comprise any of the above materials and additionally or alternatively one or more of poly (3-methyl thiophene), polyaniline, polypyrrole, poly(paraphenylene), polyacene, polythiophene, and polyacetylene. Carbonaceous capacitor materials 12 and/or 22 are surface modified to provide high material surface areas. For example, in the case of graphite, an anode host material 13 can comprise low surface area graphite which supports intercalation/deintercalation of lithium ions (via electrochemical mechanisms), whereas a capacitor material 12 and/or 22 can comprise high surface area graphite which supports adsorption/desorption of anions or cations (via physical mechanisms). The foregoing graphite comparison is similarly applicable to the other carbonaceous anode host materials 13 and capacitor materials 12 and/or 22 described herein. In some embodiments, cathode active material 23 can comprise a surface area of about 0.2 m²/gram to about 30 m²/gram. In some embodiments, anode host material 13 can comprise a surface area of about 0.5 m²/gram to about 100 m²/gram. In some embodiments, capacitor materials 12 and/or 22 can comprise a surface area of about 1.00 m²/gram to about 4,000 m²/gram.

In one embodiment, the cathode 20 comprises LFP active material 23 and AC capacitor material 22 applied to one or both sides of the cathode current collector 21, and the anode 10 comprises graphite host material 13 applied to one or both sides of the anode current collector 11. In one embodiment, the cathode 20 comprises NMC active material 23 and AC capacitor material 22 applied to one or both sides of the cathode current collector 21, and the anode 10 comprises graphite host material 13 applied to one or both sides of the anode current collector 11. In one embodiment, the cathode 20 comprises LMO active material 23 and AC capacitor material 22 applied to one or both sides of the cathode current collector 21, and the anode 10 comprises LTO host material 13 applied to one or both sides of the anode current collector 11. In one embodiment, the cathode 20 comprises NMC active material 23 and AC capacitor material 22 applied to one or both sides of the cathode current collector 21, and the anode 10 comprises LTO host material 13 applied to one or both sides of the anode current collector 11. In one embodiment, the cathode 20 comprises LFP active material 23 and AC capacitor material 22 applied to one or both sides of the cathode current collector 21, and the anode 10 comprises graphite and silicon or silicon oxide host material 13 applied to one or both sides of the anode current collector 11. In one embodiment, the cathode 20 comprises NMC active material 23 and AC capacitor material 22 applied to one or both sides of the cathode current collector 21, and the anode 10 comprises graphite and silicon or silicon oxide host material 13 host material 13 applied to one or both sides of the anode current collector 11.

Anode host material 13, cathode active material 23, and capacitor material 12 and/or 22 can further include a polymer binder material to adhere each material to its appurtenant current collector. Suitable polymer binder materials include one or more of polyvinylidene fluoride (PVDF), an ethylene propylene diene monomer (EPDM) rubber, carboxymethoxyl cellulose (CMC), and styrene, 1,3-butadiene polymer (SBR), or polytetrafluoroethylene (PTFE). The binders are ideally not electrically conducive and should be used in a minimal suitable amount to obtain a durable coating of porous electrode material without fully covering the surfaces of the particles of materials.

The separator 2 is used to prevent direct electrical contact between the anode 10 and cathode 20, and is shaped and sized to serve this function. In the assembly of CAB 1, the two electrodes are pressed against opposite sides of the separator 2, and an electrolyte 3 is disposed therebetween. For example, a liquid electrolyte 3 can be injected into the pores of the separator 2 and electrode material layers. The microporous polymer separator 2 can comprise, in one embodiment, a polyolefin. The polyolefin can be a homopolymer (derived from a single monomer constituent) or a heteropolymer (derived from more than one monomer constituent), either linear or branched. If a heteropolymer derived from two monomer constituents is employed, the polyolefin can assume any copolymer chain arrangement including those of a block copolymer or a random copolymer. The same holds true if the polyolefin is a heteropolymer derived from more than two monomer constituents. In one embodiment, the polyolefin can be polyethylene (PE), polypropylene (PP), or a blend of PE and PP. Separator 2 can optionally be ceramic-coated with materials including one or more of ceramic type aluminum oxide (e.g., Al₂O₃), and lithiated zeolite-type oxides, among others, and/or polymer-coated with materials such as PVDF, among others. Lithiated zeolite-type oxides can enhance the safety and cycle life performance of lithium ion batteries, such as CAB 1.

The microporous polymer separator 2 may be a single layer or a multi-layer laminate fabricated from either a dry or wet process. For example, in one embodiment, a single layer of the polyolefin may constitute the entirety of the microporous polymer separator 2. As another example, however, multiple discrete layers of similar or dissimilar polyolefins may be assembled into the microporous polymer separator 2. The microporous polymer separator 2 may also comprise other polymers in addition to the polyolefin such as, but not limited to, polyethylene terephthalate (PET), polyvinylidene fluoride (PVDF), and or a polyamide (Nylon). The polyolefin layer, and any other optional polymer layers, may further be included in the microporous polymer separator 2 as a fibrous layer to help provide the microporous polymer separator 2 with appropriate structural and porosity characteristics. Skilled artisans will undoubtedly know and understand the many available polymers and commercial products from which the microporous polymer separator 2 may be fabricated, as well as the many manufacturing methods that may be employed to produce the microporous polymer separator 2.

Electrolyte 3 facilitates the transport of lithium ions between Anode 10 and cathode 20. Due to the high surface area and amount of catalytically active sites at high voltages of capacitor materials 22 (e.g., activated carbon), hybrid and capacitor electrodes can generate undesired gaseous species through interactions with electrolyte 3. Carbonate-based solvents, as identified below, in particular can generate undesired gaseous species through interactions with capacitor materials 22 (e.g., activated carbon). Accordingly, provided herein are electrolytes 3 suitable for use with CABs 1 which comprise sulfones. The addition of sulfones to electrolyte 3 enables high anodic stability and suppresses or prevents such undesired gas generation. In some embodiments, the sulfone can comprise the molecule represented in chemical formula (1):

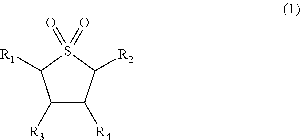

wherein each of R₁, R₂, R₃, and R₄ represents H (i.e., the sulfone comprises sulfolane), a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, a mono, di, or tri-alkyl-substituted phenyl wherein the alkyl substituent comprises CₙH₂ₙ in which n=1-20, a nitro group, a cyanogen group, or a halogen group. Accordingly, the sulfone may comprise sulfolane, or a substituted sulfolane. One such sulfone molecule defined by the molecule represented in chemical formula (1) is tetramethylene sulfone (TMS). In another embodiment, the sulfone can comprise the molecule represented in chemical formula (2):

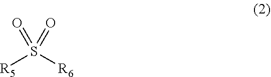

wherein each of R₅ and R₆, represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, or a mono, di, or tri-alkyl-substituted phenyl wherein the alkyl substituent comprises CₙH₂ₙ in which n=1-20. Accordingly, the sulfone may a substituted SO₂. One such sulfone molecule defined by the molecule represented in chemical formula (2) is ethyl methanesulfonate (EMS). In some embodiments, the electrolyte 3 comprises each of the sulfone molecules defined in chemical formulas (1) and (2).

The electrolyte 3 comprise up to about 80% by volume sulfone, up to about 70% by volume sulfone, or up to about 60% by volume sulfone. In other embodiments, the electrolyte 3 comprises about 10% by volume to about 35% by volume sulfone, about 15% by volume to about 30% by volume sulfone, or about 20% by volume to about 25% by volume sulfone. The concentration of sulfone within the electrolyte is balanced to inhibit the creation of gaseous species without unsuitably increasing the electrolyte 3 viscosity to undesired levels above which ion conductivity (i.e., lithium ion conductivity) decreases to undesired levels. Generally, as the molecular weight of sulfone increases, the requisite concentration of sulfone in the electrolyte 3 decreases.

Electrolyte 3 is a non-aqueous liquid electrolyte solution comprising lithium ions in the form of one or more dissolved lithium salts. A non-limiting list of suitable lithium salts that can be utilized to form the non-aqueous liquid electrolyte solution include LiCF₃S₀₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiAsF₆, and mixtures thereof. Generally, the concentration of the one or more lithium salts within the electrolyte 3 is at least about 0.1 mol/L, or such that a minimum suitable ion conductivity may be achieved. Otherwise, the concentration of the one or more lithium within the electrolyte 3 can vary, in some embodiments up to about 8 mol/L. In some embodiments, the concentration of the one or more lithium salts within the electrolyte 3 can be about 1 mol/L to about 6 mol/L.

The lithium salt(s) are typically dissolved in an organic solvent or a mixture of organic solvents including, but not limited to, cyclic carbonates (ethylene carbonate (EC), propylene carbonate (PC), butylene carbonate), acyclic carbonates (dimethyl carbonate (DMC), diethyl carbonate (DEC), ethyl methyl carbonate (EMC)), aliphatic carboxylic esters (methyl formate, methyl acetate, methyl propionate), γ-lactones (γ-butyrolactone, γ-valerolactone), ethers (dimethyl ether), chain structure ethers (1,2-dimethoxyethane, 1-2-diethoxyethane, ethoxymethoxyethane), cyclic ethers (tetrahydrofuran, 2-methyltetrahydrofuran), nitriles (acetonitrile, 3-methoxypropionitrile), and mixtures thereof. DMC can be utilized to decrease the viscosity of the electrolyte 3, in some embodiments. EMC can be utilized for low-temperature applications, in some embodiments.

In one embodiment of a CAB 1, the sulfone comprises TMS and the electrolyte 3 further comprises LiPF₆, and organic solvents EC, DMC, and EMC. The concentration of LiPF₆ is about 1.0 mol/L to about 1.4 mol/L, about 1.1 mol/L to about 1.3 mol/L, or about 1.2 mol/L. With respect to the total volumetric percent of sulfone and solvents, the concentration of TMS is about 8% to about 12%, about 9% to about 11%, or about 10%, the concentration of EC is about 20% to about 25%, about 21% to about 24%, or about 22.5%, the concentration of DMC is about 20% to about 25%, about 21% to about 24%, or about 22.5%, and the concentration of EMC is about 43% to about 47%, about 44% to about 46%, or about 45%.

In one embodiment of a CAB 1, the sulfone comprises TMS and the electrolyte 3 further comprises LiPF₆, and organic solvents EC, DMC, and EMC. The concentration of LiPF₆ is about 1.0 mol/L to about 1.4 mol/L, about 1.1 mol/L to about 1.3 mol/L, or about 1.2 mol/L. With respect to the total volumetric percent of sulfone and solvents, the concentration of TMS is about 16% to about 24%, about 18% to about 22%, or about 20%, the concentration of EC is about 16% to about 24%, about 18% to about 22%, or about 20%, the concentration of DMC is out 16% to about 24%, about 18% to about 22%, or about 20%, and the concentration of EMC is about 36% to about 44%, about 38% to about 42%, or about 40%.

In one embodiment of a CAB 1, the sulfone comprises EMS and the electrolyte 3 further comprises LiN(CF₃SO₂)₂, and organic solvents PC, DEC, and EMC. The concentration of LiPF₆ is about 1.8 mol/L to about 2.2 mol/L, about 1.9 mol/L to about 2.1 mol/L, or about 2.0 mol/L. With respect to the total volumetric percent of sulfone and solvents, the concentration of EMS is about 8% to about 12%, about 9% to about 11%, or about 10%, the concentration of PC is about 32% to about 40%, about 34% to about 38%, or about 36%, the concentration of DEC is about 23% to about 31%, about 25% to about 29%, or about 27%, and the concentration of EMC is about 23% to about 31%, about 25% to about 29%, or about 27%.

In one embodiment of a CAB 1, the sulfone comprises EMS and the electrolyte 3 further comprises lithium salts LiPF₆ and LiBF₄, and organic solvents PC, DMC, and DEC. The concentration of LiPF₆ is about 0.6 mol/L to about 1.0 mol/L, about 0.7 mol/L to about 0.9 mol/L, or about 0.8 mol/L, and the concentration of LiBF₄ is about 0.3 mol/L to about 0.5 mol/L, about 0.35 mol/L to about 0.45 mol/L, or about 0.4 mol/L. With respect to the total volumetric percent of sulfone and solvents, the concentration of EMS is about 8% to about 12%, about 9% to about 11%, or about 10%, the concentration of PC is about 32% to about 40%, about 34% to about 38%, or about 36%, the concentration of DMC is about 23% to about 31%, about 25% to about 29%, or about 27%, and the concentration of DEC is about 23% to about 31%, about 25% to about 29%, or about 27%.

In one embodiment of a CAB 1, the sulfone comprises TMS and the electrolyte 3 further comprises LiN(CF₃SO₂)₂, and organic solvent DMC. The concentration of LiN(CF₃SO₂)₂ is about 1.3 mol/L to about 1.7 mol/L, about 1.4 mol/L to about 1.6 mol/L, or about 1.5 mol/L. With respect to the total volumetric percent of sulfone and solvents, the concentration of TMS is about 56% to about 64%, about 58% to about 62%, or about 60%, and the concentration of DMC is about 36% to about 44%, about 38% to about 42%, or about 40%.

In one embodiment of a CAB 1, the sulfone comprises TMS and the electrolyte 3 further comprises lithium salts LiPF₆, LiBF₄, and LiN(CF₃SO₂)₂, and organic solvents EC, DMC, and EMC. The concentration of LiPF₆ is about 0.8 mol/L to about 1.2 mol/L, about 0.9 mol/L to about 1.1 mol/L, or about 1.0 mol/L, the concentration of LiBF₄ is about 0.1 mol/L to about 0.3 mol/L, about 0.15 mol/L to about 0.25 mol/L, or about 0.2 mol/L, and the concentration of LiN(CF₃SO₂)₂ is about 0.1 mol/L to about 0.3 mol/L, about 0.15 mol/L to about 0.25 mol/L, or about 0.2 mol/L. With respect to the total volumetric percent of sulfone and solvents, the concentration of TMS is about 16% to about 24%, about 18% to about 22%, or about 20%, the concentration of EC is about 36% to about 44%, about 38% to about 42%, or about 40%, the concentration of DMC is about 26% to about 34%, about 28% to about 32%, or about 30%, and the concentration of EMC is about 8% to about 12%, about 9% to about 11%, or about 10%.

### Example 1

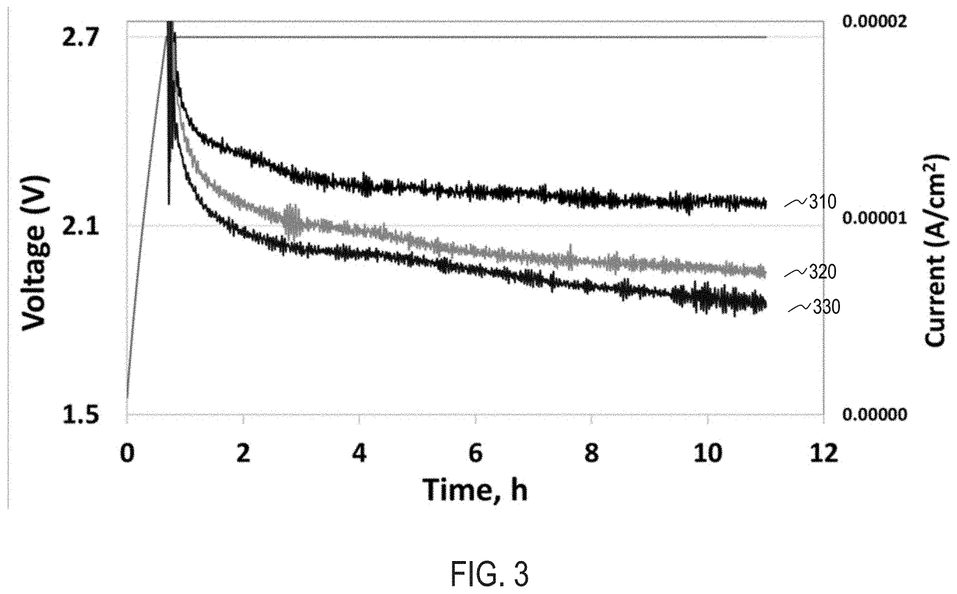

Three CABs with varying electrolyte sulfone contents were tested by charging each cell continuously to 2.7V and monitoring the current, wherein a lower current indicates a lower gas generation. Each CAB was designed similar to the CAB illustrated in FIG. 2, wherein the cathode capacitor(s) constituted 8% of the cell capacity (relative to the non-capacitor cathodes). CAB 1 included an electrolyte comprising 1.2 mol/L LiPF₆, and solvents comprising 25% EC, 25% DMC, and 50% EMC (by volume). CAB 2 included an electrolyte comprising 1.2 mol/L LiPF₆, and sulfone and solvents comprising 10% TMS, 22.5% EC, 22.5% DMC, and 45% EMC (by volume). CAB 3 included an electrolyte comprising 1.2 mol/L LiPF₆, and sulfone and solvents comprising 20% TMS, 20% EC, 20% DMC, and 40% EMC (by volume). FIG. 3 illustrates a graph of the current measured CAB 1 (310), CAB 2 (320), and CAB 3 (330). The progressively lower currents measured for CABS 2 and 3 indicate that increasing sulfone content decreases the generation of gaseous species.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A capacitor-assisted lithium battery (CAB), comprising:
a plurality of electrodes, wherein at least one or the electrodes is a hybrid battery-capacitor electrode or a capacitor electrode; and
a non-aqueous liquid electrolyte comprising one or more sulfone molecules defined by the chemical formula:

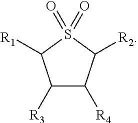

2. The CAB of claim 1, wherein each of R₁, R₂, R₃, and R₄ represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, a mono, di, or tri-alkyl-substituted phenyl wherein the alkyl substituent comprises CₙH₂ₙ in which n=1-20, a nitro group, a cyanogen group, or a halogen group.

3. The CAB of claim 1, wherein the sulfone comprises tetramethylene sulfone and the electrolyte further includes LiPF₆, ethylene carbonate, dimethyl carbonate, and ethyl methyl carbonate.

4. The CAB of claim 1, wherein the sulfone comprises tetramethylene sulfone and the electrolyte further includes LiN(CF₃SO₂)₂, and dimethyl carbonate.

5. The CAB of claim 1, wherein the sulfone comprises tetramethylene sulfone and the electrolyte further includes LiPF₆, LiBF₄, LiN(CF₃SO₂)₂, ethylene carbonate, dimethyl carbonate, and ethyl methyl carbonate.

6. The CAB of claim 1, wherein the electrolyte comprises about 15% by volume to about 30% by volume sulfone.

7. The CAB of claim 1, wherein the one or more lithium salts comprise LiCF₃SO₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiAsF₆, and combinations thereof.

8. A capacitor-assisted lithium battery (CAB), comprising
a plurality of electrodes, wherein at least one or the electrodes is a hybrid battery-capacitor electrode or a capacitor electrode; and
a non-aqueous liquid electrolyte comprising one or more sulfone molecules defined by the chemical formula:

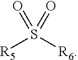

9. The CAB of claim 8, wherein each of R₅ and R₆, represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, or a mono, di, or tri-alkyl-substituted phenyl wherein the alkyl substituent comprises CₙH₂ₙ in which n=1-20.

10. The CAB of claim 8, wherein the sulfone comprises ethyl methanesulfonate and the electrolyte further includes LiN(CF₃SO₂)₂, propylene carbonate, diethyl carbonate, and ethyl methyl carbonate.

11. The CAB of claim 8, wherein the sulfone comprises ethyl methanesulfonate and the electrolyte further includes LiPF₆, propylene carbonate, dimethyl carbonate, and diethyl carbonate.

12. The CAB of claim 8, wherein the electrolyte comprises about 15% by volume to about 30% by volume sulfone.

13. The CAB of claim 8, wherein the one or more lithium salts comprise LiCF₃SO₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiASF₆, and combinations thereof.

14. A capacitor-assisted lithium battery (CAB), comprising
an electrolyte comprising one or more lithium salts, and one or more sulfone molecules defined by the chemical formula: 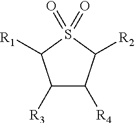
wherein each of R₁, R₂, R₃, and R₄ represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, a mono, di, or tri-alkyl-substituted phenyl wherein the alkyl substituent comprises CₙH₂ₙ in which n=1-20, a nitro group, a cyanogen group, or a halogen group,
or 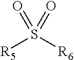
wherein each of R₅ and R₆, represents H, a linear or branched alkyl CₙH₂ₙ₊₁ wherein n=1-20, a linear or branched alkene CₙH₂ₙ wherein n=1-20, a linear or branched alkoxyl CₙH₂ₙ₊₁O wherein n=1-20, a linear or branched ether CₙH₂ₙ₊₁OCₘH₂ₘ wherein n=1-10 and m=1-10, a phenyl group, or a mono, di, or tri-alkyl-substituted phenyl wherein the alkyl substituent comprises CₙH₂ₙ in which n=1-20.

15. The CAB of claim 14, wherein up to about 60% by volume of the electrolyte comprises sulfone.

16. The CAB of claim 14, wherein the electrolyte comprises about 15% by volume to about 30% by volume sulfone.

17. The CAB of claim 14, wherein the electrolyte further comprises one or more of ethylene carbonate, diethyl carbonate, dimethyl carbonate, ethyl methyl carbonate, propylene carbonate, butylene carbonate, methyl formate, methyl acetate, methyl propionate, γ-butyrolactone, γ-valerolactone, 1,2-dimethoxyethane, 1-2-diethoxyethane, ethoxymethoxyethane, tetrahydrofuran, 2-methyltetrahydrofuran, acetonitrile, 3-methoxypropionitrile, dimethyl ether.

18. The CAB of claim 14, wherein the electrolyte further comprises a carbonate-based solvent.

19. The CAB of claim 14, wherein the one or more lithium salts comprise LiCF₃SO₃, LiN(CF₃SO₂)₂, LiNO₃, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, Li SO₃CF₃, LiAsF₆, and combinations thereof.

20. The CAB of claim 14, wherein the concentration of the lithium salt in the electrolyte is about 1 mol/L to about 6 mol/L.
